(19) United States
(12) Patent Application Publication
(10) Pub. No.: US 2021/0408789 A1
(43) Pub. Date: Dec. 30, 2021

(54) SECURE ELECTRICAL POWER GRID SIMULATION

(71) Applicant: X Development LLC, Mountain View, CA (US)

(72) Inventors: Amanda McNary, Redwood City, CA (US); Peter Evans, Los Altos Hills, CA (US)

(21) Appl. No.: 17/349,497

(22) Filed: Jun. 16, 2021

Related U.S. Application Data
(60) Provisional application No. 63/044,562, filed on Jun. 26, 2020.

(51) Int. Cl. H02J 3/00; G06F 21/53; G06F 21/62; G06F 3/0482

(52) U.S. Cl. CPC H02J 3/00; G06F 21/53; G06F 3/04855; G06F 3/0482; H02J 2203/20; G06F 21/62

(57) ABSTRACT

A method is performed by a secure execution system. The method includes: receiving, from a first system, interconnection data for a proposed interconnection to a power grid; accessing, from a second system, a power grid model including a topological representation of the power grid, electrical specifications of grid components, and empirical operation characteristics; simulating, using the power grid model, operation of the power grid with the proposed interconnection coupled to a location in the power grid identified by the interconnection data while providing security for the power grid model from access by the first system and any third party; calculating simulated power grid data, the simulated power grid data including data representing violations of a parameter of the power grid; and providing the simulated power grid data as output to the first system, to the second system, or both.

### CROSS-REFERENCE TO RELATED APPLICATION

This application claims the benefit of U.S. Application No. 63/044,562, filed Jun. 26, 2020, which is incorporated by reference in its entirety.

### TECHNICAL FIELD

The present specification relates to electrical power grids, and specifically to evaluating the technical impact of power grid interconnections on a complete grid system.

### BACKGROUND

Electrical power grids transmit electrical power to loads such as residential and commercial buildings. An interconnection to an electrical power grid can be an inverter connected resource, and may be a renewable energy source. Adding interconnections to the electrical power grid can affect conditions of the power grid. Various electrical power grid conditions can be simulated and visualized using electrical power grid models. Simulation models of electrical power grids may include sensitive information about the grid itself or other grid customers. One way of mitigating an interconnection's effect on grid conditions is to refine specific attributes of the interconnection in light of its potential impacts; however, under conventional practice such iteration may be a time-consuming and expensive process with an uncertain outcome. Such an iterative process may be made much more difficult because an entity proposing the interconnection lacks a complete understanding of the power grid, and an entity maintaining and operating the power grid lacks a complete understanding of the interconnection.

### SUMMARY

Techniques are described for secure electrical power grid interconnection simulation. An interconnection to an electrical power grid can be, but is not limited to, an inverter connected resource, also referred to as a distributed energy resource (DER). An inverter connected resource can be, for example, a renewable energy power system such as a solar power system connected to the electrical power grid.

A secure electrical power grid interconnection simulation system can perform simulations covering a wide range of operating conditions. The system can present simulation results in a way that emphasizes operating conditions and outcomes that warrant closer evaluation and the extent and persistence of those conditions. The system can simulate a proposed interconnection using a power grid model, and can protect the security of the power grid model while allowing some results of the simulation to be shared.

In general, the simulation system can allow a user such as an interconnection applicant to run simulations of a project, e.g., before applying to install the interconnection to the power grid. The system can run the simulations while providing security for the electrical grid data and for the detailed simulation results. Limited simulation results can be provided by the system to the applicant, e.g., to show the applicant the type, number, location, and frequency of violations of power grid operating parameters that would likely be caused by the interconnection. Although the simulation results provided to the applicant may be limited, the results are sufficiently comprehensive so that the results are indicative of how the interconnection would be evaluated by the grid operator when evaluating the interconnection for approval or denial. Based on the limited simulation results, the applicant can then adjust the input interconnection data and re-run the simulation. In some examples, the applicant can re-run the simulation until achieving a satisfactory result.

In an example scenario, an applicant proposes to interconnect a solar project to a power grid. Before new devices and systems are connected to the electrical power grid, it is often necessary to receive permission from the grid operator for the proposed changes. The grid operator ensures that the proposed changes are not likely to cause operation of the electrical distribution feeder to violate any limits or metrics that are put in place to ensure safe and reliable operation of the electrical power grid. The applicant can submit, through a user interface, interconnection data related to the proposed project. The interconnection data can include, for example, the location of the project and the rated output of the project. The interconnection data can also include whether the connection will be 3-phase or single phase, equipment models used in the project, and data from power output curves for the specific installation location and positioning.

Upon receiving the interconnection data, the simulation system can perform the simulation. The system may perform the simulation for a simulated period of time, e.g., one year. The system can output a display of limited results to the applicant. The limited results can show the expected type and number of electrical parameter violations caused by the proposed interconnection, the frequency of violations, and the times of day/week/year during which the violations occur. Such limited results are useful for the applicant and need not include detailed electrical grid data and detailed simulation results that may include sensitive information.

Based on the limited simulation results, the applicant can adjust the input information and re-run the simulation. For example, in a first iteration, the applicant may input a project that includes twenty solar panels. The limited simulation results may show a number of violations caused by the interconnection of this project. The applicant can then input nineteen solar panels and re-run the simulation. The applicant can continue iterations until reaching a satisfactory result, e.g., fewer or no violations caused by the interconnection. The applicant thus may refine the interconnection to reduce or avoid potential violations prior to submitting the formal application.

In some examples, the simulation system can iterate simulations in order to find a satisfactory result, with little or no input from the applicant. For example, as in the above scenario, the applicant may input a project that includes twenty solar panels, and the simulation results may show a number of violations caused by the interconnection of this project. The simulation system can continue to run the simulation with various parameter changes until reaching a satisfactory result. For example, the simulation system may simulate nineteen solar panels, eighteen solar panels, etc. until reaching a solution with fewer or no violations. In some examples, the iterations can include varying more than one input parameter. For example, the simulation system may determine that the number of solar panels needs to be decreased, and the project moved to a different location, in order to reach a no-violation solution.

In some examples, the grid operator can access the same simulation system as the applicant. The simulation system can provide different levels of access for the applicant and for the grid operator. For example, the grid operator may have full access to detailed simulation results, including simulated state conditions and configurations of the power grid. Further, the grid operator may develop and maintain the power grid model underlying the simulation system to help ensure the simulation results are valid. The applicant may be restricted to viewing only the limited simulation results.

For example, the applicant may only have access to limited simulation results including a number of violations of the proposed interconnection. In some cases, the limited simulation results may also include a time, location, severity and/or type of violation. The grid operator may be able to view not only the limited results, but also detailed results including, as an example, underlying grid elements or features that explain the violations the proposed interconnection would cause. In some examples, once the applicant achieves satisfactory results or otherwise decides to proceed, the applicant can apply for the proposed interconnection through the simulation system. Based on detailed results of the simulation, the grid operator can determine whether to approve, deny, or request modification of the interconnection. Thus, the grid operator can then review the application without having to run independent simulations.

The simulation system can include a visualizer for simulations of a power delivery system. More specifically, the visualizer can include a user interface with a “heat map” that is used to present results from a large number of power system simulation solutions. The simulation results can be presented over a simulated period of time, such as a month or year, in order to show the full time variation of the system conditions being modeled.

The visualizer can include two axes, each representing a period of time. For example, the x-axis can represent days in a year, while the y-axis can represent hours in a day. In such implementations, each coordinate in the visualizer would then correspond to an hour of the year, represented by a point on the graph. In another example, the x-axis represents weeks in a year, while the y-axis represents days in a week. In this case, each coordinate point corresponds to a day of the year. In some examples, the visualizer can display only certain time periods, e.g., only weekdays, only weekend days, only nighttime hours, etc. This can enable a viewer to identify when certain conditions occur, how persistent they are, and trends over time.

The visualizer can display simulation results of a parameter of a power grid, e.g., voltage, power, or temperature. The simulation results can include a number of violations for the parameter that occurred within the power delivery system. For the parameter of voltage magnitude, a violation can be that the voltage magnitude exceeds a set limit.

Each point of the visualizer can be color-coded to illustrate the number of violations of the parameter that occurred within the power delivery system during each time period, e.g., each hour of the year. In some examples, if the number of violations exceeds a threshold number within the hour, the point corresponding to that hour can be shaded with a designated color representing a violation. If the number of violations is below the threshold number, the point corresponding to that hour can be shaded with a designated color representing a non-violation. The visualizer can also include color gradients, with the color shading of each point corresponding to the number of violations for the parameter being represented.

A user can select various options within the user interface in order to change the view of the data. For example, the user can select a 24-hour period to view in greater detail. When the user selects the 24-hour period, the user interface can then display a graph, such as a histogram. For example, for the parameter of voltage, a histogram can display a number of violations for each hour over the course of a 24-hour period.

The visualizer can include additional displays representing the simulation results. For example, the visualizer can include a geographical and/or topological map view illustrating simulated grid conditions with the interconnection, in some cases using colors to further communicate grid conditions. The map view can include a two-dimensional or three-dimensional map view illustrating the simulated grid conditions. The visualizer can also include various charts, graphs, tables, or other means for displaying the simulation results.

The subject matter described in this specification can be implemented in various embodiments and may result in one or more of the following technical advantages. The simulation system can provide limited simulation results to interconnection applicants without disclosing sensitive information about the electrical power grid. The simulation system can run multiple instances of interconnection simulations while maintaining security for power grid models and for detailed simulation results. The simulation system can segment simulation results into time intervals, e.g., individual hours of a simulated year. The simulation system can map the simulation results to coordinates of a graph corresponding to individual time intervals, thus displaying simulation results in high resolution with respect to time.

The simulation system can conduct comprehensive interconnection evaluations using a reduced set of input data. The simulation system can perform rapid speed simulation over a variety of dynamic power grid operating conditions over a simulated period of time, e.g., based on historical power grid data. The simulation can include predicted operating conditions over discrete time intervals, e.g., over each hour of a simulated year.

Additional technical advantages of the interconnection simulation system include an ability to simulate interconnection impacts on the electrical grid under various predicted load conditions, including variations due to factors such as seasonal effects, calendar effects, and time of day effects. The interconnection simulation system can simulate interconnection impacts at multiple locations of the electrical grid. The interconnection simulation system can simulate various electrical operating characteristics, e.g., current, voltage, power factor, load, etc. at multiple locations, over prolonged simulated periods of time.

In addition, the system architecture and flow of data described herein provide a power grid simulation system with increased data security. Specifically, the systems and processes described herein permit users, e.g., the interconnection applicant, having a justified interest in evaluating the effects of an interconnection project with a power grid, to accurately simulate the impact of their particular project using a highly accurate model of a local power grid, while also retaining data security for critical or sensitive power grid data that may be included in such models.

The simulation system can allow the interconnection applicant to quickly and easily revise input data and re-run interconnection simulations to reduce or eliminate adverse grid impacts. The simulation system can provide detailed simulation results for the proposed interconnection to grid operators, prior to approval and installation. The simulation system can provide grid operators with detailed simulation results for the proposed interconnection prior to, or at the same time as, the interconnection application is submitted.

In general, innovative aspects of the subject matter described in this specification can be embodied in a method performed by a secure execution system. The method includes receiving, from a first system, interconnection data for a proposed interconnection to a power grid; accessing, from a second system, a power grid model including a topological representation of the power grid, electrical specifications of grid components, and empirical operation characteristics; simulating, using the power grid model, operation of the power grid with the proposed interconnection coupled to a location in the power grid identified by the interconnection data while providing security for the power grid model from access by the first system and any third party; calculating simulated power grid data, the simulated power grid data including data representing violations of a parameter of the power grid; providing the simulated power grid data as output (i) to the first system, (ii) to the second system, or (iii) both.

Other embodiments of this and other aspects include corresponding systems, apparatus, and computer programs, configured to perform actions of the methods encoded on computer storage devices. A system of one or more computers or other processing devices can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

These and other embodiments may each optionally include one or more of the following features, alone or in any combination.

In some implementations, the data representing violations of the parameter of the power grid includes at least one of: a time-varying number of violations of the parameter of the power grid; a type of violation of the parameter of the power grid; or a location of the violation of the parameter of the power grid.

In some implementations, providing the simulated power grid data as output includes generating a graphical user interface including a graph displaying the number of violations of the parameter of the power grid during a time period.

In some implementations, the graph includes a plurality of points. Each of the plurality of points corresponds to an x-axis coordinate and a y-axis coordinate and represents a time interval occurring during the time period; and a color shading of each of the plurality of points represents the number of violations of the parameter during the time interval.

In some implementations, the graph includes a topological map of the power grid made up of a plurality of line segments. A color shading of each of the plurality of line segments represents the number or nature of violations of the parameter during a time interval.

In some implementations, the graph includes a topological map of the power grid made up of a plurality of points. A color shading of each of the plurality of points represents the number or nature of violations of the parameter during a time interval.

In some implementations, providing security includes simulating operation of the power grid in one or more secure execution environments of the secure execution system and controlling by the secure execution system all communications of data and models into or out of the one or more secure execution environments.

In some implementations, the method includes accessing, from a third system, weather data at a location of the proposed interconnection; and providing the weather data to the one or more secure execution environments to compute a simulated time-varying power output of the proposed interconnection, he simulated time-varying power output of the proposed interconnection may be based on the weather data.

In some implementations, the interconnection data for the proposed interconnection to the power grid includes one or more of a location, a size, a positioning, a power output, or a connecting phase of the proposed interconnection.

In some implementations, the parameter of the power grid includes one or more of steady-state voltage, current, power, power factor, load, utilization, or temperature.

In some implementations, the parameter of the power grid includes one or more of transient voltage, current, power, power factor, load, utilization, or temperature.

In some implementations, providing the simulated power grid data as output (i) to the first system, (ii) to the second system, or (iii) both includes: providing a first subset of simulated power grid data as output to the first system; and providing the first subset and a second subset of simulated power grid data to the second system; and preventing access to the second subset of simulated power grid data by the first system and any third party.

In some implementations, the method includes preventing access to the second system by the first system.

In some implementations, the method includes preventing access to the power grid model by the first system.

In some implementations, the system provides suggested interconnection data as output. The suggested interconnection data includes proposed revisions to the interconnection data based on the simulated power grid data.

Another innovative aspect of the subject matter described in this specification can be embodied in a computer-implemented method executed by one or more processors. The method includes obtaining power grid data including time-varying parameters of a power grid; identifying, within the power grid data, a number of violations of one or more operating parameters of the power grid; and generating a graphical user interface including a graph representing the power grid data. The graph includes: an x-axis representing progression of time measured by a first time increment over a first time period and a y-axis representing progression of time measured by a second time increment over a second time period. The second time period is equal to the first time increment. The graph includes a plurality of points. Each of the plurality of points corresponds to an x-axis coordinate and a y-axis coordinate and represents a time interval occurring during the first time period. A color shading of each of the plurality of points represents the number of violations of the parameter during the time interval.

In some implementations, the method includes segmenting the power grid data into time intervals matching the first time increment and the second time increment; tagging each time interval of the segmented power grid data with a respective x-coordinate and y-coordinate pair; and mapping the tagged power grid data to coordinates of the graph corresponding to the respective x-coordinate and y-coordinate pairs.

In some implementations, the first time period includes a year, the first time increment includes a day, and the second time increment includes an hour.

In some implementations, the first time period includes a year, the first time increment includes a week, and the second time increment includes a day.

In some implementations, the first time period includes a year, the first time increment includes a week, and the second time increment includes an hour.

In some implementations, the power grid data includes simulated power grid data.

In some implementations, the power grid data includes historical power grid data.

In some implementations, the violations of the parameter of the power grid include violations of the parameter at any location of the power grid.

In some implementations, the violations of the parameter of the power grid include violations of the parameter at one or more selected locations of the power grid.

In some implementations, the color shading of each of the plurality of points represents a binary indication of the number of violations of the parameter during the time interval.

In some implementations, the color shading of each of the plurality of points represents a graded indication of the number of violations of the parameter during the time interval.

Another innovative aspect of the subject matter described in this specification can be embodied in computer-implemented method executed by one or more processors, the method including obtaining power grid data including time-varying parameters of a power grid; identifying, within the power grid data, a number of violations of one or more operating parameters of the power grid; and generating a graphical user interface including a graph representing the power grid data. The graph includes: an x-axis representing progression of time measured by days, a y-axis representing progression of time measured by hours, and a plurality of points. Each of the plurality of points corresponds to an x-axis coordinate and a y-axis coordinate and represents an hour of a day occurring during a year; and a color shading of each of the plurality of points represents the number of violations of the parameter during the hour of the day.

Other implementations of the above aspects include corresponding systems, apparatus, and computer programs, configured to perform the actions of the methods, encoded on computer storage devices. The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for secure electrical power grid interconnection simulation that supports iterative refinement of input interconnection data by an interconnection applicant.

FIG. 2 illustrates an example user interface for input of interconnection data.

FIGS. 3A-3B illustrate example user interfaces for display of interconnection simulation results to an interconnection applicant.

FIG. 4 illustrates an example user interface showing input results and a suggested solution, respectively.

FIG. 5 illustrates an example of a user interface for display of interconnection simulation results to a grid operator.

FIG. 6 illustrates an example process for secure electrical power grid interconnection simulation.

### DETAILED DESCRIPTION

This disclosure generally describes computer-implemented methods, software, and systems for secure electrical power grid interconnection simulation. A computing system can simulate time-varying electrical parameters of a power grid based on a power grid model. Electrical parameters can include, for example, power flow, voltage, power factor, load, phase imbalance, and asset utilization. These parameters can be coupled; for example, some parameters may influence others and/or their temporal and spatial dependence may be related.

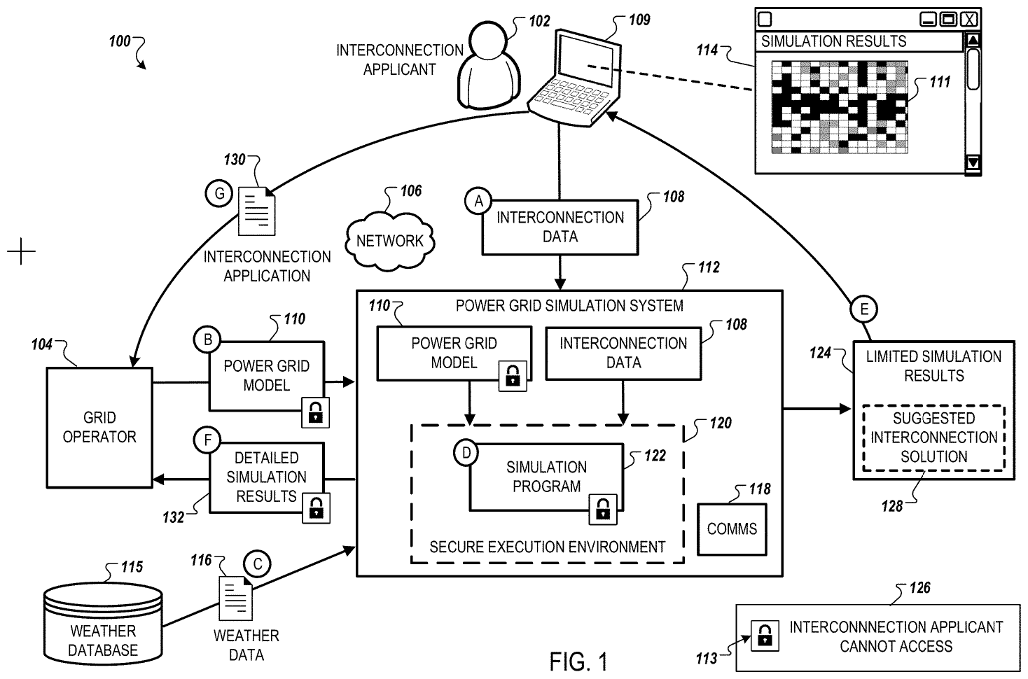

FIG. 1 illustrates an example system for secure electrical power grid interconnection simulation. The system 100 includes a power grid simulation system 112, a grid operator 104, and a user device 109 accessible by an interconnection applicant 102. Each of these components can communicate with one another, e.g., over a data communication network 106. In general, the system 100 can include more than one interconnection applicant 102, and more than one grid operator 104 that communicate with one another. The network 106 can include public and/or private wired or wireless networks, and can include the Internet.

The user device 109 can be an electronic device such as a computing device. The user device 109 can be, for example, a desktop computer, a laptop computer, a smart phone, a cell phone, a tablet, a PDA, etc. The user device 109 is accessible by the interconnection applicant 102.

The simulation system 112 can be a server system and can include one or more computing devices. In some implementations, the simulation system 112 may be part of a cloud computing platform. The simulation system 112 includes a secure execution environment 120 that can receive a power grid model 110 and interconnection data 108, and securely produce simulation results by executing one or more simulation programs 122 to analyze impacts of the proposed interconnection, while providing security for the power grid model 110 from outside access.

The interconnection applicant 102 can be any person or organization having interest in making additions and/or changes to an electrical power grid. The applicant 102 can be, for example, a project developer, property owner, or construction company.

The grid operator 104 can be, for example, a utility or government entity having an interest in or responsible for accommodating interconnection requests while maintaining the integrity and performance of the power grid. Prior to permitting installation of an interconnection, the grid operator 104 can review results of the interconnection simulation system to predict impacts of the electrical grid operation with the interconnection.

The system can include one or more communication subsystems 118 for use by the simulation system 112 to communicate with external parties. For example, the communication subsystems can receive the power grid model 110 from the grid operator 104 and the interconnection data 108 from the applicant 102. The simulation system 112 can also transmit data to the external parties using the communication subsystems. In some implementations, the communication subsystem 118 receives sensitive information from the parties locally or over a secure protocol. For example, the protocol can be a secure shell protocol (SSH) file transfer protocol, secure file transfer protocol (SFTP), gRPC (gRPC Remote Procedure Call) or other network transfer protocol.

The weather database 115 can store weather data 116. The weather database 115 can store historical weather data 116 for the general geographic location of the power grid. For example, the weather data 116 can include time-varying temperatures, sunlight incident angles, and atmospheric conditions. In some examples, the weather database 115 can store averaged historical weather data. For example, the weather database 115 can store temperatures for each hour of a simulated year, based on averaged historical temperatures.

In some examples, the weather database 115 can store detailed weather data for specific locations within the general geographic location of the power grid. For example, the general geographic location of the power grid may be a county, state, or province. A specific location within the general geographic location can include an individual town, city, or zip code area.

When running a simulation, the power grid simulation system 112 can retrieve weather data 116 for the specific location of the proposed interconnection, as identified in the interconnection data 108. For example, the interconnection data 108 can include a street address, town, zip code, or latitude and longitude for the proposed interconnection. The simulation system 112 can retrieve the weather data 116 for the specified location from the weather database 115.

In general, the interconnection applicant 102 can provide interconnection data 108 to a simulation system 112 through an input user interface provided through the user device 109. The grid operator 104 can provide a power grid model 110 to the simulation system 112. The simulation system 112 can input the power grid model 110 and the interconnection data 108 into a simulation program 122 in the secure execution environment 120. The simulation system 112 can provide limited simulation results 124 to the interconnection applicant 102, and detailed simulation results 132 to the grid operator 104. The user device 109 can present the limited simulation results through an output user interface 114. Interconnection applicants may use the limited simulation results 124 as a basis for submitting an interconnection application 130 to the grid operator 104. Interconnection applicants may also repeat the simulation process by submitting revised interconnection data 108 and receiving revised limited simulation results 124 prior to submitting an interconnection application 130, to improve chances of acceptance by the grid operator 104. The grid operator 104 may review the detailed simulation results 132 to inform decisions to approve or deny interconnection applications.

FIG. 1 illustrates various events, shown as stages (A) to (G), with each representing a stage of secure electrical power grid interconnection simulation. Stages (A) to (G) may occur in the illustrated sequence, or in a sequence that is different from the illustrated sequence. For example, some of the stages may occur concurrently.

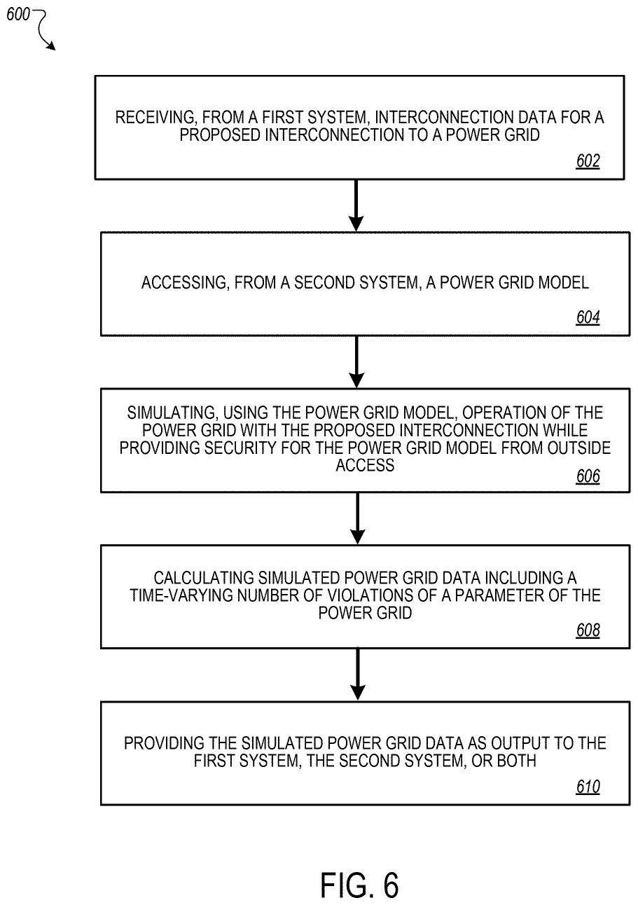

The system 100 can perform secure electrical power grid interconnection simulation using a process 600, shown in FIG. 6. The process 600 includes receiving, from a first system, interconnection data for a proposed interconnection to a power grid (602). The power grid can be an electrical power grid that transmits electrical power to loads such as residential and commercial buildings. The proposed interconnection can be any change made to existing distribution feeders. The proposed interconnection can be, for example, a new building, renewable power plant, or stationary or mobile power storage facility. The proposed interconnection can also be, for example, an expansion to an existing building, facility, or electrical load. The interconnection data for the proposed interconnection to the power grid can include, for example, a location, a size, a positioning, a power output, or a connecting phase of the proposed interconnection. The first system can be, for example, the user device 109.

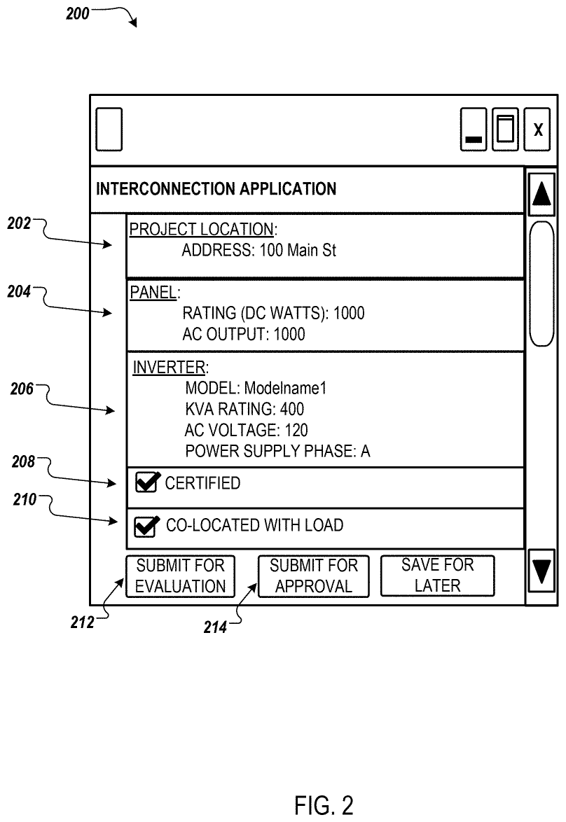

For example, in stage (A) of FIG. 1, the power grid simulation system 112 receives the interconnection data 108 from the user device 109. The user device 109 can send the interconnection data 108 to the power grid simulation system 112, e.g., over the network 106. The interconnection data 108 can be input to the user device 109 by the interconnection applicant 102 through an input user interface. The input user interface can include input fields for various data. For example, the input user interface can include an input field for project location, panel, and inverter details. The input user interface is described in greater detail with reference to FIG. 2.

The process 600 includes accessing, from a second system, a power grid model (604). The power grid model can include a model of real-world power grid assets. The second system can be, for example, a computing system of the grid operator 104.

For example, in stage (B) of FIG. 1, the grid operator 104 sends the power grid model 110 to the power grid simulation system 112, e.g., over the network 106. In some examples, the power grid model 110 can be stored in one or more databases operated by the grid operator 104. In some examples, the power grid model 110 can be updated routinely in order to reflect a current as-built electrical power grid. In some examples, the power grid model 110 can include modifications, e.g., interconnections, that have been approved but not yet installed.

In some examples, the grid operator 104 can provide the power grid model 110 to the simulation system 112 in response to the simulation system 112 receiving the interconnection data 108. For example, the simulation system 112 may retrieve the power grid model 110 from the grid operator 104 based on the location of the proposed interconnection included in the interconnection data 108. In some examples, the grid operator 104 can provide the grid model 110 to the simulation system 112 when updates are made to the grid model 110. In some examples, the grid operator 104 may employ one or more features or practices to ensure that the grid model 110 is representative of the as-built power grid system, and that simulation results 124 and 132 based on the grid model 110 are valid to the extent practical.

In some examples, the grid model 110 may be developed, maintained, updated, and/or provided by an entity other than the grid operator 104.

In some examples, the power grid model 110 can include a high resolution model of one or more electrical distribution feeders. The power grid model 110 can include, for example, data models of substation transformers, medium voltage distribution lines, distribution switches and reclosers, fixed and switched capacitors, voltage regulation schemes, e.g., tapped magnetics or switched capacitors, network transformers, load transformers, inverters, generators, and various loads. The power grid model 110 can also include transformer locations and capacities, feeder locations and capacities, and load locations.

The power grid model 110 may be calibrated by using measured electrical power grid data. The measured electrical power grid data can include historical grid operating data. The historical grid operating data can be collected during grid operation over a period of time, e.g., a number of weeks, months, or years. In some examples, the historical grid operating data can be average historical operating data. For example, historical grid operating data can include an electrical load on a substation during a particular hour of the year, averaged over multiple years. In another example, historical grid operating data can include a number of voltage violations of the electrical power grid during a particular hour of the year, averaged over multiple years.

In some examples, the grid model 110 can include assumptions. For example, the grid model 110 can include measured data for certain locations of the power grid, and might not include measured data for other locations. The grid model 110 can use assumptions to interpolate grid operating data for locations in which measurements are not available. An assumption can be, for example, an assumed ratio or relationship between loads at industrial locations of the power grid compared to residential locations of the power grid.

In some examples, the grid model 110 can include measured data for certain time intervals, e.g., certain hours, and might not include measured data for other time intervals. The grid model 110 can use assumptions to estimate or interpolate grid operating data for time intervals in which measurements are not available. An assumption can be, for example, an assumed relationship between loads at a particular location at nighttime compared to daytime. In another example, an assumption can be an assumed relationship between loads at a particular location during an hour of the day in summertime, compared to during the same hour of the day in wintertime.

In some examples, the grid model 110 can include measured data for certain characteristics, e.g., electrical load, and might not include measured data for characteristics. The grid model 110 can use assumptions to estimate grid operating data for characteristics for which measurements are not available. An assumption can be, for example, an assumed relationship between load and voltage at a particular location of the power grid.

In some examples, the measured data can be used to resolve and reduce errors caused by assumptions in the power grid model 110. In some examples, the power grid model 110 can include conservative values in place of missing or incomplete data. In some examples, the power grid model 110 can use worst case assumptions to enable worst case analysis.

In stage (C) of FIG. 1, the simulation system 112, optionally, receives weather data 116 from a third system, e.g., the weather database 115. The simulation system 112 can receive, from the weather database, weather data at a location of the proposed interconnection. The simulation system 112 can provide the weather data to the one or more secure execution environments to compute a simulated time-varying power output of the proposed interconnection. The simulated time-varying power output of the proposed interconnection can be based on the weather data. In some examples, the simulation system 112 can retrieve the weather data 116 based on the location of the proposed interconnection included in the interconnection data 108.

Once the simulation system 112 has received the interconnection data 108, the power grid model 110, and the weather data 116 from the weather database 115, the system can instantiate the secure execution environment 120 to run the simulation program 122.

The process 600 includes simulating, using the power grid model, operation of the power grid with the proposed interconnection while providing security for the model from outside access (606). Providing security can include simulating operation of the power grid in one or more secure execution environments 120 of the simulation system 112 and controlling by the simulation system 112 all communications of data and models into or out of the one or more secure execution environments 120.

The simulation program 122 can simulate operation of the power grid with the proposed interconnection coupled to a location in the power grid identified by the interconnection data. The location in the power grid can include a geographic location identified by the interconnection data. For example, the location can include a postal address or a latitude and longitude coordinate position. The simulated power grid data can be based on the proposed interconnection coupled, or electrically connected, to the power grid at the identified location.

The simulation program 122 can analyze the expected operation of the power grid with the interconnection installed by applying empirical historical data to the grid model with the interconnection installed. The empirical historical data can include historical electrical grid characteristics based on, for example, measurements, calculations, estimates, and interpolations. The characteristics can include, for example, load, voltage, current, and power factor. The empirical historical data can represent power grid operation of multiple interconnected components within a designated geographical area. The empirical historical data can represent average electrical grid operating characteristics over a period of time, e.g., multiple weeks, months, or years.

For example, in stage (D) of FIG. 1, the simulation system 112 provides the interconnection data 108 to the simulation program 122 in the secure execution environment 120 provided by the system that is specially configured to run the simulation program 122 while protecting the confidentiality of the data. The simulation system 112 can run the simulation program 122 in virtual machines or other secure execution environment instances, e.g., containers or sandboxes.

To reduce the risk that the grid model 110 or its algorithms will be exposed to unauthorized disclosure from reverse engineering or otherwise, implementations of the simulation system 112 include one or more of the following features. The simulation program 122 can be stored on the simulation system 112 in encrypted form and decrypted only into memory of the secure execution environment 120 when the simulation program 122 is to be executed. Optionally, the simulation system 112 can execute the simulation program in a secure execution environment 120 that uses hardware-supported trusted execution environments of a CPU (central processing unit) or a secure element microprocessor for the protection of the simulation program 122 and the grid model 110.

As noted above, the simulation system 112 can run the simulation program 122 in virtual machines or other secure execution environment instances, e.g., containers or sandboxes. These instances are configured to have limited access to data, communications, and storage, other than what is specifically provided in order to support the processing of the confidential data. Specifically, to make the instances secure, the simulation system 112 limits the ability of the secure execution environment 120 to store and communicate data. The simulation system 112 can also optionally prevent the secure execution environment 120 from storing any data in non-volatile memory, in order to protect the grid model 110. The simulation system 112 can do this, for example, by configuring the secure execution environment 120 with no access to non-volatile storage.

The simulation system 112 allows output from the simulation program 122 to be sent only through a secure communication channel, which will only send it to the interconnection applicant 102 or the grid operator 104.

In some implementations, the simulation system 112 can run multiple simulation programs 122 in multiple secure execution environments 120. The simulation system 112 can prevent instances of simulation programs 122 in each virtual machine from communicating with one another. Thus, during the simulation system 112′s execution of the simulation programs, the simulation system 112 protects confidential data by preventing the simulation programs 122 from communicating with other components or services internal or external to the simulation system 112 except as explicitly permitted.

The simulation program 122 simulates operation of the power grid, including the proposed interconnection, during a simulated time period. The simulations can be based on, for example, root-mean-square (RMS), power flow, and/or transient analysis. In some examples, an interconnection such as an inverter connected resource may cause transients of the electrical power grid. For example, an interconnection may cause sudden changes in voltage magnitude and phase on the electrical power grid. Multiple interconnections can amplify the sudden changes, and may cause cascading trips.

In some examples, the simulations can cover a range of operating conditions, including under extremes of voltage from the Bulk Power System (BPS) and extremes in load on the electrical distribution feeder. The simulation program 122 can simulate corner cases of the system with the proposed interconnection added to the existing system as dictated by good engineering practice or as required under interconnection standards. The simulations can also cover electrical grid conditions during steady-state operation and during transient operation.

The process 600 includes calculating simulated power grid data including data representing violations of a parameter of the power grid (608). The simulated power grid data can also include a number of different temporal and spatially dependent parameters or parameters of the power grid. The parameters can include, for example, steady-state or transient voltage, current, power, power factor, load, utilization, and temperature.

A violation can be based on, for example, an industry standard metric for the power grid. An example violation can be, for example, a thermal limit violation, a backfeed constraint violation, a power violation, or a voltage violation. In some examples, the violations of the parameter of the power grid include violations of the parameter at any location of the power grid. In some examples, the violations of the parameter of the power grid include violations of the parameter at one or more selected locations of the power grid, or in one or more regions of the power grid. For example, the power grid can include sensors for a particular parameter positioned at one or more selected locations. The violations of the particular parameter can include violations at the positions of the respective sensors.

The simulated time period can be, for example, a simulated year. In some examples, the simulation program 122 can generate simulated power grid data, or simulation results, for each hour of the simulated year. The simulation can include predicted loads and transients over the course of the simulated year based on historical data. For example, predicted loads may vary based on predicted seasonal effects (e.g., based on the weather data 116) and calendar effects (e.g., weekends, holidays).

As an example, the simulation program 122 can generate simulated power grid data including voltage magnitude violations. The simulation program 122 can identify particular grid locations and simulated times of the voltage magnitude violations over the simulated time period. The simulation program 122 can also identify a total number of voltage magnitude violations at any location of the power grid during each increment of the simulated time period. For example, the simulation program 122 can determine a number of voltage magnitude violations that occurs during each hour of the simulated year, showing whether such violations are persistent, limited to particular days or hours, etc.

In addition to voltage magnitude violations, other example violations can include violations associated with voltage variability, voltage fluctuations, periodic voltage deviations, voltage transients, thermal limit violations, and backfeed constraints. The metrics can also include transient overvoltage violations, overvoltage magnitude, phase shift magnitude, power flow violations, and power magnitude violations. The simulation program 122 can identify the number of violations of each evaluated parameter in steady-state, transient, and dynamic conditions.

The process 600 includes providing the simulated power grid data as output to the first system, the second system, or both (610). In some examples, providing the simulated power grid data as output can include providing a first subset of simulated power grid data, e.g., the limited simulation results 124, as output to the first system, e.g., the user device 109. Providing the simulated power grid data as output can also include providing the first subset and a second subset of simulated power grid data, e.g., the detailed simulation results 132, to the second system, e.g., the grid operator 104. The first subset can include non-sensitive simulated power grid data, including, particularly, information about parameter violations that is of greatest interest and use to the user, and can be provided to the user device 109. The first subset can also be provided to the grid operator 104. The second subset can include sensitive simulation data, and can be provided only to the grid operator 104. Providing the simulated power grid data as output can include preventing access to the second subset of simulated power grid data by the user device 109 and any third party.

Providing the simulated power grid data as output can include generating a graphical user interface 114 including a graph 111 displaying the number of violations of the parameter of the power grid during a simulated time period. To generate the graphical user interface, the simulation system 112 can segment the power grid data into time intervals matching the first time increment and the second time increment. The simulation system 112 can tag each time interval of the segmented power grid data with a respective x-coordinate and y-coordinate pair. The simulation system 112 can map the tagged power grid data to coordinates of the graph 111 corresponding to the respective x-coordinate and y-coordinate pairs.

For example, in stage (E) of FIG. 1, the simulation system 112 outputs the first subset of simulated power grid data to the user device 109 as limited simulation results 124. In stage (F), the simulation system 112 outputs the first subset and the second subset of simulated power grid data to the grid operator 104 as detailed simulation results 132. The user device 109 can present the limited simulation results 124 to the interconnection applicant 102, e.g., through an output user interface 114.

In some examples, the limited simulation results 124 can include a suggested interconnection solution 128. The suggested interconnection solution 128 can include recommended changes to the proposed interconnection. The suggested interconnection solution 128 can include suggested interconnection data. The suggested interconnection data can include proposed revisions to the interconnection data 108 based on the limited simulation results 124 or the detailed simulation results 132. The suggested interconnection solution 128 can be a solution that, when simulated by the simulation program 122, reduces the number of violations, or eliminates the violations.

The suggested interconnection solution 128 can include recommendation changes to the proposed interconnection. For example, the recommended changes can include a curtailment, rebuild of electrical assets, addition of storage, reduction of size, voltage controls, etc. Upon display of the suggested interconnection solution 128 to the interconnection applicant 102, the interconnection applicant 102 may then choose to incorporate the recommended modifications and resubmit the interconnection data 108 to the simulation system 112.

The user device 109 can display the limited simulation results 124 to the interconnection applicant 102 through the output user interface 114. In some examples, the output user interface 114 can display a visualization of the limited simulation results 124 in the graph 111. Though shown in the example of FIG. 1 as a “heat map” visualizer, the user device 109 can display the limited simulation results 124 in any appropriate visual format, such as charts, graphs, tables, or other means for displaying the simulation results.

For example, the user device 109 can display the limited simulation results 124 as a geographical and/or topological map view illustrating simulated grid conditions with the interconnection. The topological map of the power grid can be made up of line segments or points. A color shading of each of the line segments or points can represent the number of violations of the parameter during a time interval.

In some examples, the level of detail of information to be included in the limited simulation results 124 can be determined based on settings input by the grid operator 104. For example, the grid operator 104 may input a setting that the limited simulation results 124 include a time and type of violation, but not a location of a violation. In another example, the grid operator 104 may determine that the limited simulation results 124 include a time, type, and location of violation, but not a severity of a violation.

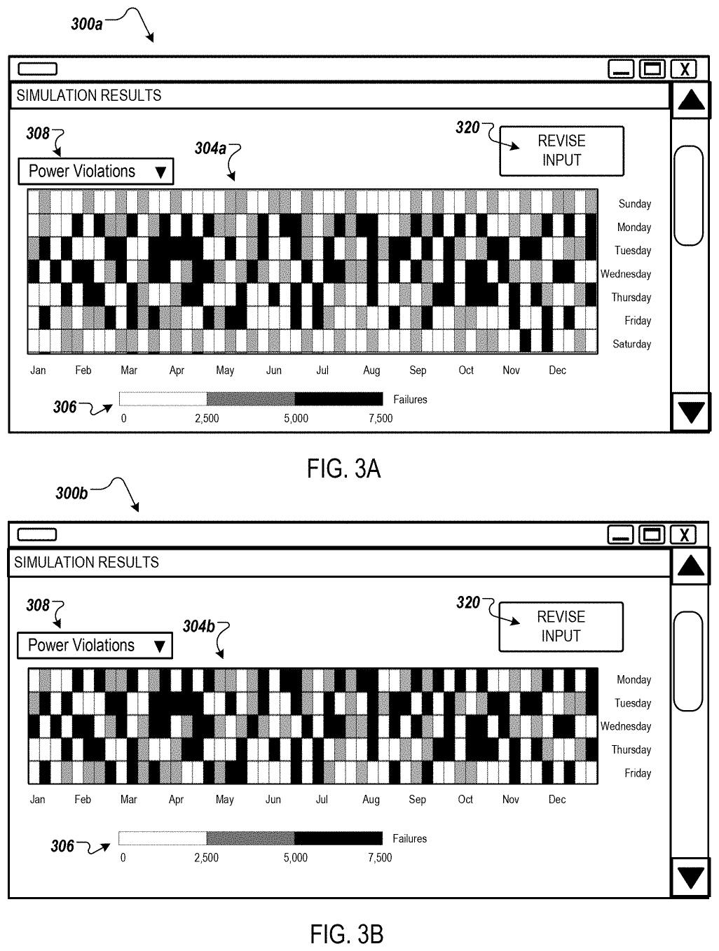

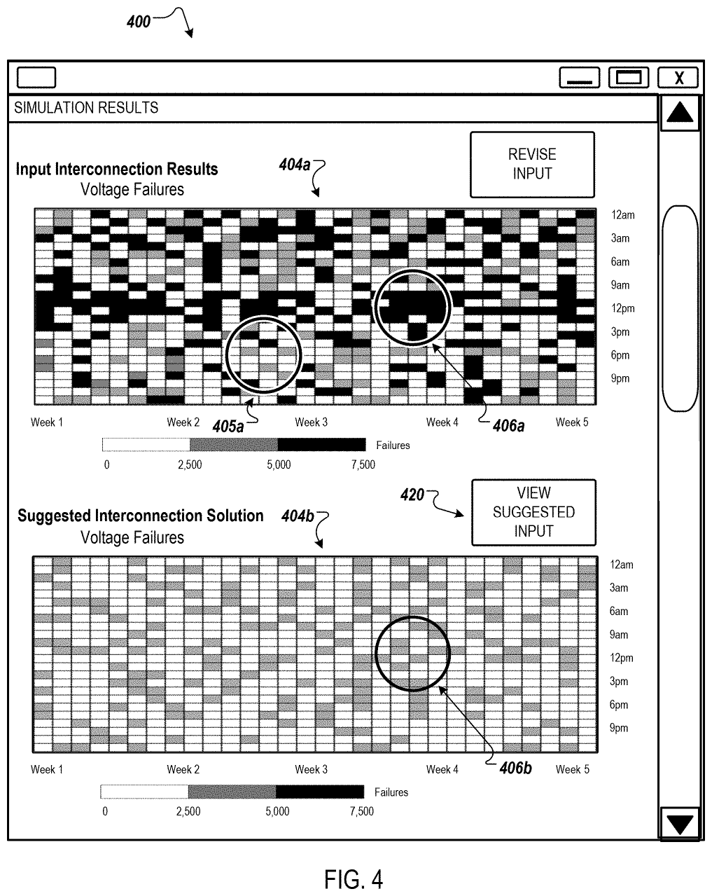

The graph 111 can include a number of points. Each point corresponds to an x-axis coordinate and a y-axis coordinate and represents a time interval occurring during the simulated time period. In some examples, an x-axis represents progression of time measured by a first time increment over a first time period, and a y-axis represents progression of time measured by a second time increment over a second time period. The second time period can be equal to the first time increment. A color shading of each point can represent the number of violations of the parameter during the time interval. The graph 111 is described in greater detail with reference to FIGS. 3A, 3B, 4A, and 4B.

In some examples, the output user interface 114 can display a time-varying graph, e.g., a line graph or a bar graph that shows the number of violations over a period of time. The output user interface 114 can be interactive in order to enable the interconnection applicant 102 to examine the results. For example, the interconnection applicant 102 can select, e.g., using a computer mouse, an individual test, time period, or location, in order to view respective detailed simulation results.

The applicant 102 may re-run the simulation multiple times. In some examples, the applicant 102 can revise the project parameters of the interconnection data 108, with or without a suggested interconnection solution 128, have the proposed interconnection re-analyzed by the simulation system 112. The applicant 102 can then receive new limited simulation results 124 that includes a revised set of violations. In some examples, the applicant can iteratively revise away violations in order to reduce the violations displayed on the graph 111. In some examples, the interconnection applicant 102 can revise the proposed interconnection based on the suggested interconnection solution 128.

The grid operator 104 can independently review the detailed simulation results 132, e.g., as presented through a user interface of a computer display. The detailed simulation results 132 can include the graph 111, as well as additional graphs and views. In some examples, the grid operator 104 can view the detailed simulation results 132 in a two-dimensional and/or three-dimensional map view.

In stage (G) of FIG. 1, the interconnection applicant 102 can submit the interconnection application 130 to the grid operator 104. The interconnection applicant 102 can submit the interconnection application 130, for example, after reviewing the limited simulation results 124 and particularly after one or more refinements of the interconnection data 108 and re-evaluation in the simulation system 112. In this way, the interconnection applicant 102 can directly use the simulation system 112 to refine the interconnection to reduce or eliminate violations prior to submitting the interconnection application, and to understand the expected impacts of the proposed interconnection on the power grid.

The grid operator 104 can review the interconnection application 130. The grid operator 104 can evaluate the interconnection application 130 based on the detailed simulation results 132. In this way, the grid operator 104 can receive interconnection applications that are complete and for which some analysis has been done. The grid operator 104 may be able to review and approve or deny the interconnection application 130 without performing additional simulations.

As has just been described, the system implements a number of features to ensure the interconnection applicant 102 cannot access the power grid model 110. This is illustrated in FIG. 1, where a legend 126 illustrates items that the interconnection applicant 102 cannot access. The legend 126 illustrates a lock 113, which represents data, e.g., the power grid model 110, the simulation program 122, and the detailed simulation results 132, that the interconnection applicant 102 and other third parties cannot access.

FIG. 2 illustrates an example user interface for input of interconnection data. The user interface 200 shows data for a proposed solar panel interconnection. The user interface 200 can be displayed to a user through a user device, e.g., the user device 109 of the system 100.

The applicant can input a set of project parameters (e.g. size, type, location). In some examples, the applicant can be offered the use of library or default project parameters, e.g., if the project is in a very early stage.

The user interface 200 includes an input field for project location data 202. The project location data can include, for example, a street address of the proposed interconnection, or a parcel number, or a latitude and longitude of the proposed interconnection. In some examples, the project location data can include an allowed variability for the proposed location of the interconnection. In some examples the precise point of coupling between the interconnection and the power grid such as feeder and structure may be determined by the system 112 based on the input project location data 202.

The user interface 200 also includes input fields for panel details 204 and inverter details 206. The panel details 204 can include a power rating and an AC output for the solar panels. The inverter details 206 can include an inverter model, power rating, voltage rating, and power supply phase for the inverter. The user interface 200 can include input fields indicating whether the inverter is certified 208 and whether the inverter is co-located with the load 210.

The user interface 200 can also include input fields for additional details that are not shown in FIG. 2. For example, the user interface can include input fields for an applicant or owner name, a power factor range, and an alternating current connection type.

The user interface 200 can also include a user-selectable icon 212 for submitting the interconnection data for evaluation by the simulation system. Once the user selects the user-selectable icon 212, the user device 109 can send the interconnection data collected through the user interface 200 to the power grid simulation system 112, as illustrated in stage (A) of FIG. 1.

The user interface 200 can include a user-selectable icon 214 for submitting the interconnection data for review and approval by the grid operator 104. Once the user selects the user-selectable icon 214, the user device 109 can send the interconnection data collected through the user interface 200 to the grid operator 104, as illustrated in stage (G) of FIG. 1.

FIGS. 3A-3B illustrate example user interfaces for display of interconnection simulation results to an interconnection applicant.

In FIG. 3A, the user interface 300a shows data for a proposed solar panel interconnection, e.g., the proposed interconnection that was submitted through the user interface 200. The user interface 300a can be displayed to a user through a user device, e.g., the user device 109 of the system 100. The user interface 300a can display results from an interconnection simulation, e.g., limited simulation results 124.

The user interface 300a includes an example graph 304a showing a number of power violations, or failures, over a simulated period of time. The graph 304a is a visualizer that presents simulation results in a color-coded “heat map.” The graph 304a includes an x-axis representing progression of time measured by a first time increment, e.g., weeks, over a first time period, e.g., a year. The graph 304a includes a y-axis representing progression of time measured by a second time increment, e.g., days, over a second time period, e.g., a week.

In some examples, the time increments and time period can be selected by the user. For example, the user may be able to select to view a graph showing violations in increments of days during weeks of a year, as shown in FIGS. 3A and 3B. The user may also be able to select to view a graph showing violations in increments of hours during days of a month, as will be shown in FIG. 4.

The graph 304a shows a number of points. Each point corresponds to an x-axis coordinate and a y-axis coordinate. Each point represents a time interval, e.g., one day, occurring during the time period of one year. A color shading of each point represents the number of violations of an electrical grid parameter during the time interval.

In some examples, the color shading of each point represents a binary indication of the number of violations of the parameter during the time interval. For example, a first color can represent the number of violations being less than a threshold number of violations, and a second color can represent the number of violations being more than a threshold number of violations.

In some examples, the color shading of each point represents a graded indication of the number of violations of the parameter during the time interval. For example, a first color can represent the number of violations being within a first range, a second color can represent the number of violations being within a second range, and a third color can represent the number of violations being within a third range.

In some examples, the time period can include a year, the first time increment can include a day, and the second time increment can include an hour. In some examples, the time period can include a year, the first time increment can include a week, and the second time increment can include a day. In some examples, the time period can include a year, the first time increment can include a week, and the second time increment can include an hour.

For simplicity, only three ranges of failures are shown in the graph 304 of FIG. 3. In accordance with legend 306, grid coordinates shaded white represent times during which the number of failures was between 0 and 2,500. Grid coordinates shaded gray represent times during which the number of failures was between 2,500 and 5,000. Grid coordinates shaded black represent times during which the number of failures was between 5,000 and 7,500. Additional ranges can be included, and can be represented by any color-coding scheme. In some examples, the color shading may be a gradient shading.

In some examples, in response to a user selecting a point of the graph 304, the user interface 300a can display one or more graphs showing time-varying trends of power failures. For example, the graphs can be line graphs or bar graphs. The graphs can show a number of power failures, e.g., by time of day or by day of week.

In some examples, e.g., based on user preferences and settings, the user interface can display selected simulation results and can exclude certain simulation results. An example is shown in FIG. 3B.

In FIG. 3B, the user interface 300b shows interconnection data for the proposed solar panel interconnection for a selection of time intervals. For example, the user interface 300b includes an example graph 304b showing a number of power violations over a simulated year, excluding weekends. Thus, the graph 304b shows the limited simulation results 124 only for weekdays Monday through Friday, for a simulated time period of a year. By excluding limited simulation results 124 for simulated weekends, the user can focus on time intervals of likely high electrical power usage.

In some examples, the user interface can display or exclude any selected time intervals. For example, a graph of weeks over a year can include only weekdays, only weekdays, or both. A graph of days over a year can include or exclude certain hours of each day, e.g., nighttime hours or daytime hours.

Although the graphs 304a, 304b show power violations, the graphs 304a, 304b can show violations for any simulated parameter. In some examples, the user interfaces 300a, 300b can include an option for the user to switch between viewing different metrics. For example, the user interfaces 300a, 300b can include drop-down selectable icon 308 to enable selection of other metrics, e.g., voltage violations.

The user interfaces 300a, 300b can include a user-selectable icon 320 for revising input data. The input data can be, for example, the interconnection data 108 of FIG. 1. In response to a user selecting the icon 320, the user device 109 can display an input user interface, e.g., the user interface 200. The user can then revise the interconnection data 108 and re-submit for simulation.

FIG. 4 illustrates an example user interface showing input interconnection results and a suggested interconnection solution. The user interface 400 includes an example graph 404a showing a number of voltage failures over a simulated period of time, based on simulation of the proposed interconnection as input. The graph 404a includes an x-axis representing progression of time measured by a first time increment, e.g., days, over a first time period, e.g., five weeks. The graph 304a includes a y-axis representing progression of time measured by a second time increment, e.g., hours, over a second time period, e.g., a day.

The graph 404a shows a number of black-shaded points, indicating a number of hours during the five week period during which the number of voltage failures is between 5,000 and 7,500. Presenting the interconnection results in the format shown in FIG. 4 can enable the user to identify trends more readily. For example, as shown in graph 404a, a greater number of violations are shown to occur during the middle of the daytime than in the morning or the evening. For example, during the time increments in highlighted region 406a, which includes mid-day time increments, there are more violations, represented by black-shaded points, than during the time increments in highlighted region 405a, which includes late afternoon and evening time increments. Based on these identified trends, the user can revise the interconnection data to reduce the number of violations during the time increments of highest violations.

The black-shaded points can indicate that the proposed interconnection, if installed, would likely result in a large number of power system voltage violations. This may result in the electrical power grid requiring power system upgrades. The results as shown in the graph 404a may also cause the grid operator to deny the interconnection application.

The user interface 400 includes an example graph 404b showing a number of voltage failures over a simulated period of time, based on a suggested interconnection solution 128. The suggested interconnection solution 128 can be a solution generated by the simulation system 112, based on the simulation results shown in graph 404a.

The graph 404a shows no black-shaded points, indicating no hours during the five week period during which the number of voltage failures is between 5,000 and 7,500. The absence of black-shaded points can indicate that the suggested interconnection, if installed, would likely result in fewer voltage violations compared to the original proposed interconnection.

By comparing the graph 404a with the graph 404b, the user can identify changes in violation trends. For example, the time increments in highlighted region 406b correspond to the same time increments of highlighted region 406a. The user can identify that there are fewer violations in the highlighted region 406b than during the time increments in highlighted region 406a, as illustrated by the absence of black-shaded points.

The user interface 400 can include a user-selectable icon 420 for viewing suggested input. For example, in response to a user selecting the icon 420, the user device 109 can display a list of suggested interconnection parameters that, when simulated, produce the graph 404b. The user can then revise the input interconnection data to reflect the suggested interconnection solution.

The user interface 400 can allow a user to compare power grid conditions based on the input interconnection data to power grid conditions based on the suggested interconnection solution. In some examples, the user interface 400 can display a graph representing historical power grid conditions, and a graph representing simulated power grid conditions with a proposed interconnection. Thus, the user interface 400 can allow a user to compare historical power grid conditions to simulated power grid conditions in order to determine an impact of the proposed interconnection.

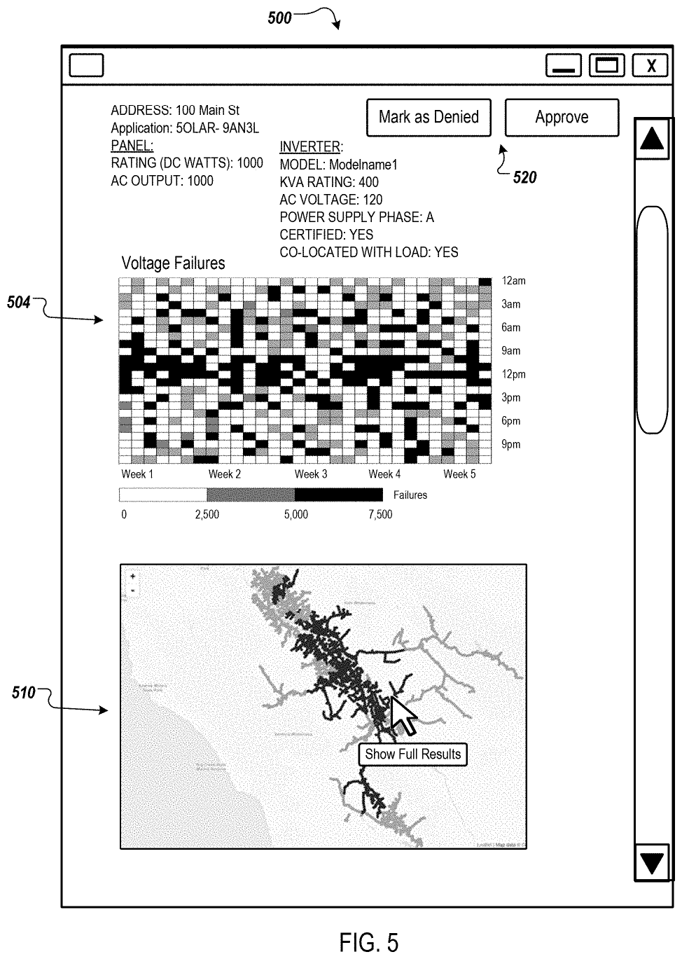

FIG. 5 illustrates an example of a user interface 500 for display of interconnection simulation results, e.g., to a grid operator. The user interface 500 shows output results for an interconnection simulation, e.g., detailed simulation results 132 for the proposed interconnection that was submitted through the user interface 200.

Similar to the user interfaces 300a, 300b, the user interface 500 shows a graph 504 showing a number of voltage failures over a period of time. The user interface 500 also shows a two-dimensional map view 510 of voltage failures. Graph 504 shows the temporal nature of the violation, and the two-dimensional map view 510 shows the nature of the violation in terms of system topology and geography.

The two-dimensional map view 510 shows a line-diagram representation of power lines in the power grid overlaid on a map of a geographic region in which the power grid is located. The line-diagram includes a number of line segments. A color shading of each line segment can be used to represent the evaluation results at a particular spatial location of the power grid. The evaluation results can be for a particular simulated time, or can be averaged or accumulated over a period of simulated time.

Attributes of the line segments of the two-dimensional map view 510 can represent parameters of the simulated electrical power grid operation. An attribute can be, for example, a color, shading, or thickness of the line segment. Parameters of the simulated operation can include e.g., voltage, real power, power factor, line utilization, and transformer utilization. Parameters of the simulated operation can also include violations of electrical power grid metrics. For example, the attributes of the line segments can represent a location of voltage failures.

In FIG. 5, line segments represent locations of electrical power grid components. Dark shaded line segments represent locations of the electrical power grid where there are no violations, or where the number of violations is below a threshold limit. Light shaded line segments represent locations of the electrical power grid where there are violations, or where the number of violations is above a threshold limit.

In some examples, in response to a user selecting a point of the line segments, the two-dimensional map view 510 can display detailed simulation results. The detailed simulation results can include, for example, a number of violations that occurred in the corresponding grid location over the simulated period of time. The detailed simulation results can also include a total number of violations that occurred in the corresponding grid location during the simulated time period.

In some examples, the user interface 500 can include user-selectable icons 520 for approving or denying the proposed interconnection. For example, the user may be a grid operator. Based on reviewing the simulation results as displayed through the user interface 300, the grid operator can select to approve or deny the interconnection.

Though described as including certain elements and features, the user interface 300 can include more elements or fewer elements. For example, a user may adjust settings and preferences for the elements displayed on the user interface. In some examples, a user may select a preference to view a two-dimensional map view of the grid instead of, or in addition to, the graph 304. In some examples, the user may select to view power failures instead of, or in addition to, voltage failures.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art.

For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A method performed by a secure execution system, the method comprising:
receiving, from a first system, interconnection data for a proposed interconnection to a power grid;
accessing, from a second system, a power grid model comprising a topological representation of the power grid, electrical specifications of grid components, and empirical operation characteristics;
simulating, using the power grid model, operation of the power grid with the proposed interconnection coupled to a location in the power grid identified by the interconnection data while providing security for the power grid model from access by the first system and any third party;
calculating simulated power grid data, the simulated power grid data comprising data representing violations of a parameter of the power grid; and
providing the simulated power grid data as output (i) to the first system, (ii) to the second system, or (iii) both.

2. The method of claim 1, wherein the data representing violations of the parameter of the power grid comprises at least one of:
a time-varying number of violations of the parameter of the power grid;
a type of violation of the parameter of the power grid; or
a location of the violation of the parameter of the power grid.

3. The method of claim 1, wherein providing the simulated power grid data as output comprises generating a graphical user interface comprising a graph displaying a number of violations of the parameter of the power grid during a time period.

4. The method of claim 3, wherein the graph comprises a plurality of points, wherein:
each of the plurality of points corresponds to an x-axis coordinate and a y-axis coordinate and represents a time interval occurring during the time period; and
a color shading of each of the plurality of points represents the number of violations of the parameter during the time interval.

5. The method of claim 3, wherein the graph comprises a topological map of the power grid made up of a plurality of line segments, wherein:
a color shading of each of the plurality of line segments represents the number of violations of the parameter during a time interval.

6. The method of claim 3, wherein the graph comprises a topological map of the power grid made up of a plurality of points, wherein:
a color shading of each of the plurality of points represents the number of violations of the parameter during a time interval.

7. The method of claim 1, wherein providing security comprises:
simulating operation of the power grid in one or more secure execution environments of the secure execution system and controlling by the secure execution system all communications of data and models into or out of the one or more secure execution environments.

8. The method of claim 7, further comprising:
accessing, from a third system, weather data at a location of the proposed interconnection; and
providing the weather data to the one or more secure execution environments to compute a simulated time-varying power output of the proposed interconnection,
wherein the simulated time-varying power output of the proposed interconnection is based on the weather data.

9. The method of claim 1, wherein the interconnection data for the proposed interconnection to the power grid comprises one or more of a location, a size, a positioning, a power output, or a connecting phase of the proposed interconnection.

10. The method of claim 1, wherein the parameter of the power grid comprises one or more of steady-state voltage, current, power, power factor, load, utilization, or temperature.

11. The method of claim 1, wherein the parameter of the power grid comprises one or more of transient voltage, current, power, power factor, load, utilization, or temperature.

12. The method of claim 1, wherein providing the simulated power grid data as output (i) to the first system, (ii) to the second system, or (iii) both comprises:
providing a first subset of simulated power grid data as output to the first system; and
providing the first subset and a second subset of simulated power grid data to the second system; and
preventing access to the second subset of simulated power grid data by the first system and any third party.

13. The method of claim 1, comprising preventing access to the second system by the first system.

14. The method of claim 1, comprising preventing access to the power grid model by the first system.

15. The method of claim 1, wherein the first system is accessible to a user or applicant for an interconnection both to provide either initial or revised interconnection data and to receive simulated power grid data, and the second system is accessible to a grid operator and not to the user of the first system or any third party.

16. The method of claim 1, comprising providing suggested interconnection data as output, wherein the suggested interconnection data comprises proposed revisions to the interconnection data based on the simulated power grid data.

17. A computer-implemented method executed by one or more processors, the method comprising:
obtaining power grid data comprising time-varying parameters of a power grid;
identifying, within the power grid data, a number of violations of one or more operating parameters of the power grid; and
generating a graphical user interface comprising a graph representing the power grid data, wherein the graph comprises:
an x-axis representing progression of time measured by a first time increment over a first time period;
a y-axis representing progression of time measured by a second time increment over a second time period, wherein the second time period is equal to the first time increment; and
a plurality of points, wherein:
each of the plurality of points corresponds to an x-axis coordinate and a y-axis coordinate and represents a time interval occurring during the first time period; and
a color shading of each of the plurality of points represents the number of violations of the parameter during the time interval.

18. The method of claim 17, further comprising:
segmenting the power grid data into time intervals matching the first time increment and the second time increment;
tagging each time interval of the segmented power grid data with a respective x-coordinate and y-coordinate pair; and
mapping the tagged power grid data to coordinates of the graph corresponding to the respective x-coordinate and y-coordinate pairs.

19. The method of claim 17, wherein the first time period comprises a year, the first time increment comprises one of a week or a day, and the second time increment comprises one of a day or an hour.

20. The method of claim 17, wherein the violations of the parameter of the power grid comprise one of (i) violations of the parameter at any location of the power grid or (ii) violations of the parameter at one or more selected locations of the power grid.

21. The method of claim 17, wherein the color shading of each of the plurality of points represents one of (i) a binary indication of the number of violations of the parameter during the time interval or (ii) a graded indication of the number of violations of the parameter during the time interval.

22. A computer-implemented method executed by one or more processors, the method comprising:
obtaining power grid data comprising time-varying parameters of a power grid;
identifying, within the power grid data, a number of violations of one or more operating parameters of the power grid; and
generating a graphical user interface comprising a graph representing the power grid data, wherein the graph comprises:
an x-axis representing progression of time measured by days,
a y-axis representing progression of time measured by hours, and
a plurality of points, wherein:
each of the plurality of points corresponds to an x-axis coordinate and a y-axis coordinate and represents an hour of a day occurring during a year; and
a color shading of each of the plurality of points represents the number of violations of the parameter during the hour of the day.
